(19) United States
(12) Patent Application Publication
(10) Pub. No.: US 2015/0006405 A1
(43) Pub. Date: Jan. 1, 2015

(54) SYSTEM AND METHODS FOR SECURE ENTRY OF A PERSONAL IDENTIFICATION NUMBER (PIN) USING MULTI-TOUCH TRACKPAD TECHNOLOGIES

(71) Applicants: James Roy PALMER, San Jose, CA (US); Michael VOEGE, San Jose, CA (US)

(72) Inventors: James Roy PALMER, San Jose, CA (US); Michael VOEGE, San Jose, CA (US)

(21) Appl. No.: 13/931,423

(22) Filed: Jun. 28, 2013

(51) Int. Cl. G06Q 20/38; H04L 29/06

(52) U.S. Cl. CPC G06Q 20/38215; H04L 63/0853
USPC 705/72; 705/76

(57) ABSTRACT

Systems and methods for entering credential components are provided. The system includes an input device coupled to a computing device. The input device includes an input pad configured to receive a tactile input corresponding to the credential components, and one or more processors. The one or more processors of the input device are configured to recognize one or more characters traced on the input pad by the tactile input, encrypt the recognized one or more characters, and send the encrypted one or more characters. The computing device receives the encrypted one or more characters and includes one or more processors configured to display instructions to provide the tactile input, and send the received encrypted one or more characters to a remote server.

### BACKGROUND

1. Technical Field

Embodiments disclosed herein are related to systems and methods for enabling the secure entry of credentials such as personal identification numbers (PINs). In particular, systems and methods disclosed herein may provide for the secure input of a PIN on an input device that performs character recognition traced on an input surface to recognize the components or digits of the PIN.

2. Related Art

Integrated circuit (IC) cards, also known as “Chip and PIN” cards or Europay, MasterCard and Visa (EMV) cards have become the standard financial transaction cards, also known as credit or debit cards, that are used in Europe. These cards include an integrated circuit chip embedded thereon which is designed to be read by an IC chip reader at a point of sale (POS) terminal when conducting a financial transaction, such as purchasing goods. In order to authenticate the transaction, the payer is typically required to enter a PIN associated with the IC chip using a keypad on the POS terminal. In addition to, or instead of, entering a PIN, a payer may be required to authenticate the transaction using a signature.

Modern mobile devices are capable as acting as POS terminals using a card reader in communication with the mobile device, such as the PayPal Here™ device offered by PayPal of San Jose, Calif. However, these devices are currently only able to process traditional magnetic stripe financial transaction cards. Efforts to develop an IC chip reader for use with a mobile device have had difficulty in gaining approval and certification due to the inherent insecurity of the mobile device. Mobile devices may have malware executing thereon which may be designed to capture a user's PIN or other information from the IC chip that could be read by a mobile IC chip reader. Moreover, certification may require some level of accessibility for those who have vision difficulties.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a diagram illustrating a system including a client computing device in communication with an input unit, consistent with some embodiments.

FIG. 4 is a diagram illustrating a system including client computing device in communication with input unit having a card or IC chip reader, consistent with some embodiments.

FIG. 5 is a diagram illustrating a flow of using system to conduct a transaction, consistent with some embodiments.

FIG. 6 is a diagram illustrating a system including an input device in communication with an automatic teller machine, consistent with some embodiments.

FIG. 7 is a flowchart illustrating a method for credential character entry, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Consistent with some embodiments, there is provided a system for entering credential components. The system includes an input device having an input pad configured to receive a tactile input corresponding to the credential components, and one or more processors. The one or more processors of the input device are configured to recognize one or more credential components from the received tactile input, encrypt the recognized one or more credential components, and send the encrypted one or more credential components. The system also includes a computing device coupled to the input device. The computing device receives the encrypted one or more credential components and includes one or more processors configured to display instructions to provide the tactile input, and send the received encrypted one or more credential components to a remote server.

Consistent with some embodiments, there is also provided a method for credential component entry. The method includes steps of receiving, by an input pad of an input device, a tactile input corresponding to credential components, recognizing the credential components corresponding to the received tactile input, encrypting the recognized credential components, receiving, by a computing device coupled to the input device, the encrypted recognized credential components, and sending, by the computing device, the encrypted recognized credential components to a remote server.

Embodiments consistent with this disclosure may allow users to securely enter a credential by tracing components of the credential on a device. Character recognition may then be performed on the traced components to recognize the components, and the recognized components can be encrypted and sent to a payment processing server to authorize a payment. By requiring tracing for entry of a credential, the credential may not be visible to third parties and those around the user. Moreover, by allowing tracing secure credential entry may also be performed by the vision impaired.

These and other embodiments will be described in further detail below with respect to the following figures.

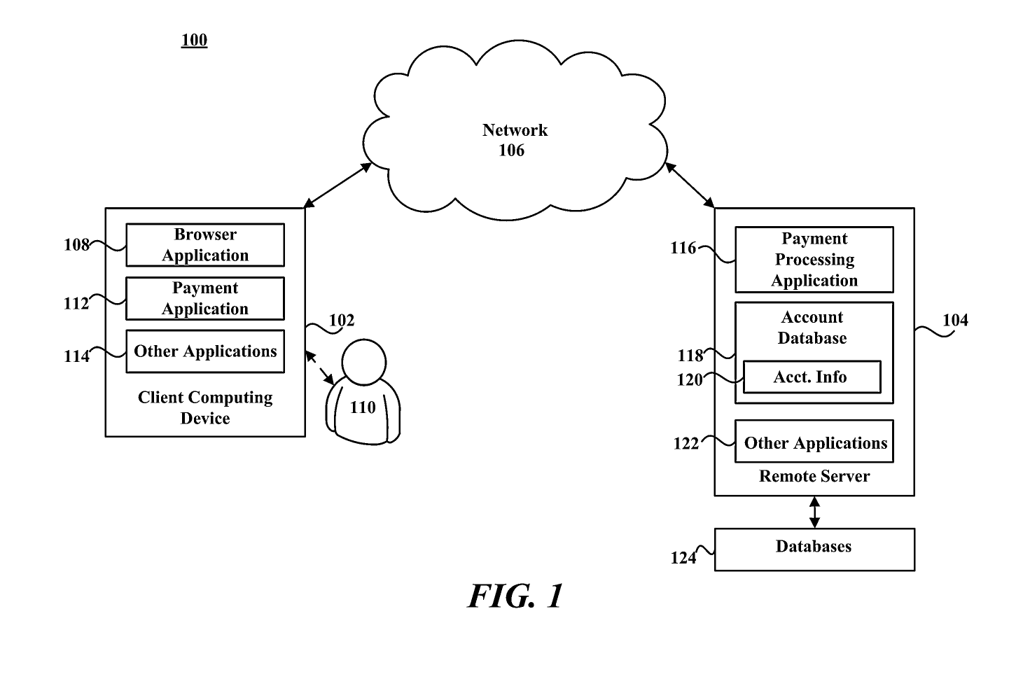

FIG. 1 is a block diagram of a networked system 100, consistent with some embodiments. System 100 includes a client computing device 102 and a remote server 104 in communication over a network 106. Remote server 104 may be a payment service provider server that may be maintained by a payment provider, such as PayPal, Inc. of San Jose, Calif. Remote server 104 may be maintained by other service providers in different embodiments. Remote server 104 may also be maintained by an entity with which sensitive credentials and information may be exchanged with client computing device 102. Remote server 104 may be more generally a web site, an online content manager, a service provider, such as a bank, or other entity who provides content to a user requiring user authentication or login.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client computing device 102, in one embodiment, may be implemented using any appropriate combination of hardware and/or software configured for wired and/or wireless communication over network 106. For example, client computing device 102 may be implemented as a wireless telephone (e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

Consistent with some embodiments, client computing device 102 may include any appropriate combination of hardware and/or software having one or more processors and capable of reading instructions stored on a tangible non-transitory machine-readable medium for execution by the one or more processors. Consistent with some embodiments, client computing device 102 includes a machine-readable medium, such as a memory (not shown) that includes instructions for execution by one or more processors (not shown) for causing client computing device 102 to perform specific tasks. For example, such instructions may include browser application 108 such as a mobile browser application, which may be used to provide a user interface to permit a user 110 to browse information available over network 106. For example, browser application 108 may be implemented as a web browser to view information available over network 106. Browser application 108 may include a graphical user interface (GUI) that is configured to allow user 110 to interface and communicate with remote server 104 or other servers managed by content providers or merchants via network 106. For example, user 110 may be able to access websites to find and purchase items, as well as access user account information or web content.

Client computing device 102 may also a payment application 112 may allow user 110 to enter into and perform transactions over network 106, including authorizing payments to be processed by a payment service processing provider, such as may be provided by PayPal, Inc. of San Jose, Calif. and implemented by remote server 104. In some embodiments, user 110 of client computing device 102 may be a merchant or a customer, purchaser, or buyer. Payment application 112 may be configured to work with a separate display device (not shown) to provide transaction information to the display device and the receive from the display device an encrypted credential that authorizes a payment to complete the transaction, such that payment application 112 of client computing device 102 may send the encrypted credential to remote server 104 over network 106 for processing the authorized payment.

Client computing device 102 may include other applications 114 as may be desired in one or more embodiments to provide additional features available to user 110, including accessing a user account with remote server 104. For example, applications 114 may include interfaces and communication protocols that allow the user to receive and transmit information through network 106 and to remote server 104 and other online sites. Applications 114 may also include security applications for implementing client-side security features, programmatic client applications for interfacing with appropriate APIs over network 106 or various other types of generally known programs and/or applications. Applications 114 may include mobile applications downloaded and resident on client computing device 102 that enables user 110 to access content through the applications.

Remote server 104, according to some embodiments, may be maintained by an online payment provider, which may provide processing for online financial and payment transactions on behalf of user 110. Remote server 104 may include at least payment processing application 116, which may be configured to interact with payment application 112 of client computing device 102 over network 106 to receive and process payments. Remote server 104 may also include an account database 118 that includes account information 120 for users having an account on remote server 104, such as user 110. In some embodiments, account application payment processing application 116 may process payments based on information in account information 120 of account database 118 for buyers and merchants, referred to generally as user 110. Remote server 104 may include other applications 122, such as may be provided for authenticating users to remote server 104. Remote server 104 may also be in communication with one or more external databases 124, that may provide additional information that may be used by remote server 104. In some embodiments, databases 124 may be databases maintained by third parties, and may include third party account information of user 110.

Although discussion has been made of applications and applications on client computing device 102 and remote server 104, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications.

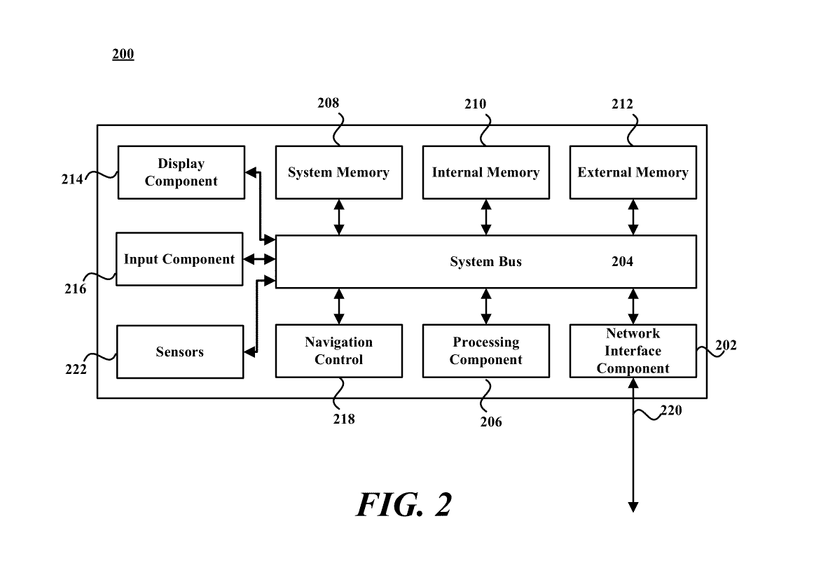

FIG. 2 is a diagram illustrating computing system 200, which may correspond to either of client computing device 102 or remote server 104, consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with client computing device 102. Further, computing system 200 may also be a server or one server amongst a plurality of servers, as would be consistent with remote server 104. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communication information between the various components. Such components include a processing component 206, which may be one or more processors, micro-controllers, graphics processing units (GPUs) or digital signal processors (DSPs), a system memory component 208, which may correspond to random access memory (RAM), an internal memory component 210, which may correspond to read-only memory (ROM), and an external or static memory 212, which may correspond to optical, magnetic, or solid-state memories. Consistent with some embodiments, computing system 200 further includes a display component 214 for displaying information to a user 120 of computing system 200. Display component 214 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 216, allowing for a user 120 of computing system 200 to input information to computing system 200. Such information could include payment information such as an amount required to complete a transaction, account information, authentication information such as a credential, or identification information. An input component 216 may include, for example, a keyboard or key pad, whether physical or virtual. Computing system 200 may further include a navigation control component 218, configured to allow a user to navigate along display component 214. Consistent with some embodiments, navigation control component 218 may be a mouse, a trackball, or other such device. Moreover, if device 200 includes a touch screen, display component 214, input component 216, and navigation control 218 may be a single integrated component, such as a capacitive sensor-based touch screen.

Computing system 200 may perform specific operations by processing component 206 executing one or more sequences of instructions contained in system memory component 208, internal memory component 210, and/or external or static memory 212. In other embodiments, hard-wired circuitry may be used in place of or in combination with software instructions to implement the present disclosure. Logic may be encoded in a computer readable medium, which may refer to any medium that participates in providing instructions to processing component 206 for execution. Such a medium may take many forms, including but not limited to, non-volatile media, volatile media, and transmission media. The medium may correspond to any of system memory 208, internal memory 210 and/or external or static memory 212. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. According to some embodiments, transmission media may take the form of acoustic or light waves, such as those generated during radio wave and infrared data communications. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 220 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 220 and network interface component 202. Communication link 220 may be wireless through a wireless data protocol such as Wi-Fi™, 3G, 4G, HDSPA, LTE, RF, NFC, or through a wired connection. Network interface component 202 may include an antenna, either separate or integrated, to enable transmission and reception via communication link 220. Received program code may be executed by processing component 206 as received and/or stored in memory 208, 210, or 212.

Computing system 200 may also include sensor components 222. Sensor components 222 may include any sensory device that captures information related to the surroundings of computing system 200. Sensor components 222 may include camera and imaging components, accelerometers, GPS devices, motion capture devices, and biometric sensors, and other devices that are capable of providing information about computing system 200, user 120, or their surroundings. In some embodiments, sensor components 222 including an accelerometer may be used to detect a motion of computing system 200 made by a user that may be indicative of a user recognition of a displayed character or digit of a credential. Sensor components 222 may include a microphone configured to detect a voice of user 120 and translate the detected voice into an electrical signal that may be interpreted by processing component as corresponding to text or characters.

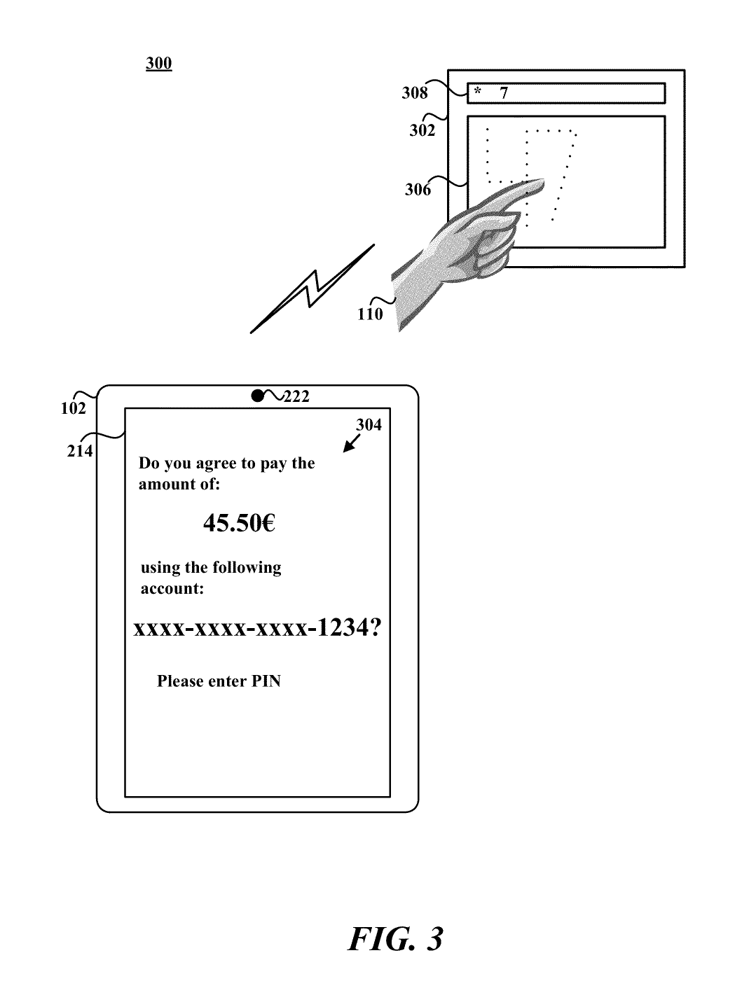

FIG. 3 is a diagram illustrating a system 300 including a client computing device 102 in communication with a input unit 302, consistent with some embodiments. Input unit 302 may include one or more processors (not shown) and a machine-readable medium, such as a memory (not shown) that includes instructions for execution by the one or more processors (not shown) for causing input unit 302 to perform specific tasks. For example, such instructions may include receiving a tactile input from a user 110, performing character recognition on the tactile input, encrypting information, and transmitting the encrypted information to client computing device 102. Client computing device 102 may be in communication with input unit 302 using a wireless connection, such as a Bluetooth™ connection, a Wi-Fi connection, an infrared (IR) connection, or other such wireless connections. Client computing device 102 may also be in communication with input unit 302 using a wired connection or, in some embodiments, input unit 302 may be directly coupled to client computing device 102 using a plug-in coupling. As shown in FIG. 3, client computing device 102 may include a user interface 304 that is configured to display payment and/or transaction information to user 110. User interface 304 may be displayed by a display component 214 of computing system 200. In some embodiments, information displayed in user interface may be also or alternatively displayed on input device 302.

Although not shown, input unit 302 may also include one or more processors, a memory, and a network interface component similar to the one or more processors, memory, and network interface component of computing system 200, described above. The one or more processors, memory, and network interface component may be integrated on a single integrated circuit, such as an application-specific integrated circuit (ASIC), or on multiple integrated circuits. In some embodiments, input unit 302 is a minimalist device that may not be running any operating system and. In some embodiments, input unit 302 may be a secure device that is only in communication with client computing device 102, making it more difficult for malware to reach input unit 302. In such embodiments, input unit 302 may only be in communication with a single client computing device 102 at a time, with the specific client computing device 102 in communication with input unit 302 may be changed by a user.

Input unit 302 may also include an input pad 306. Input pad 306 may be configured to receive an input from a user and perform one or more recognition algorithms on the input. The recognition algorithms may be known recognition algorithms, such as tactile character recognition algorithms, optical character recognition algorithms, handwriting analysis algorithms, and the like. The recognition algorithms may also incorporate machine-based learning algorithms. In some embodiments, input pad 306 may receive a tactile input from user 110. The received tactile input may be one or more credential components that is written or traced on input pad 306 by user 110. In some embodiments, the tactile input may be written or traced on input pad using a stylus, a pen, a finger, or other object. In some embodiments, input pad may be a touch-sensitive input pad configured to detect a touch on a surface of pad 306 and detect movements of the touch. For example, input pad 306 may be a capacitive or conductance touch sensing pad, a pressure-sensitive touch pad, or a combination thereof. Input pad 306 may also be capable of detecting one or more touches (e.g., multi-touch) at the same time. In some embodiments, input pad 306 may also be capable of detecting biometric information, such as the pressure, speed, handwriting, of the received tactile input. In some embodiments, input pad 306 may include an image capture device, such as a camera, to capture one or more images of the received input and perform one or more character recognition algorithms on the captured one or more images to determine the characters being input, the characters corresponding to components of a credential. Input device 302 may receive a tactile input, encrypt the received tactile input, and send the encrypted input to client computing device 102.

In some embodiments, the input may be credential characters or components of a credential such as a personal identification number (PIN). The recognition algorithms performed by the one or more processors of input device 302 may be capable of recognizing letters, numbers, and other characters, such as foreign language characters. The recognition algorithms may also be capable of recognizing written words and translating the written words to numbers, such as writing “four”, “quatre”, or “quatro” as a “4” credential component of the credential.

In some embodiments, input device 302 including input pad 306 may be incorporated within or as part of client computing device 102. For example, if display component 214 of client computing device is a touch-sensitive screen, display component 214 may be used as input pad 306 of input device 302 for receiving an input and performing character recognition algorithms on the received input.

As shown in FIG. 3, system 300 may be used to authorize a payment. As shown in FIG. 3, display component 214 of client computing device 102 may display an interface 304 showing transaction information for review by user 110. Client computing device 102 may then transmit information to input pad 306, such as transaction information and a flag, trigger, or alert that a tactile input is required. User 110 may then enter a tactile input to authorize the transaction based on the details shown in interface 304. For example, a credential such as a personal identification number (PIN) may be required to be entered to authorize the transaction displayed in interface 304. User 110 may then provide the credential or PIN via a tactile input on input pad 306 by tracing the numbers of the PIN on input pad 306. The numbers shown on input pad 306 in FIG. 3 are for illustration only. No actual numbers will be displayed on input pad 306. Moreover, user 110 may trace the numbers of the PIN, or other credential component, one component at a time, such that each credential component is traced over the previous component.

After receiving the tactile input, the one or more processors of input pad 306 may perform character recognition on the tactile input to recognize the credential components (such as PIN numbers) that were entered by user. After the credential components have been recognized, input pad may encrypt the entered credential and other relevant information and send the encrypted information to client computing device 102. Payment application 112 of client computing device 102 may then send the received encrypted information to remote server 104 for processing the authorized payment. In some embodiments, input device 302 may check an accuracy or correctness of the credential entered by tactile input before transmitting to client computing device 102.

Moreover, input device 302 may include a button, which may be physical or rendered on pad 306, that may be used by user 110 to indicate that they have completed entering the credential components using tactile input. Input device 302 may also include an indicator that may indicate when each credential component has been entered and recognized by input device 302. Input device 302 may also include an additional indicator that may provide an indication that the required number of credential components has been entered. Such indicators may include light emitting diodes (LEDs) on input device 302 or rendered indications on pad 306. Such indicators may also be provided by audio or vibration.

In some embodiments, input device 302 may also include a display 308. Display 308 may be capable of displaying the recognized characters. The recognized characters or credential components may be temporarily displayed, and then replaced with a dot or asterisk, or otherwise masked after a predetermined amount of time to comply with standards and ensure that a third party is unable to see a completed credential. In some embodiments, display 308 may be configured to display additional information, such as instructions for using input device 302 for confirmation of an entered credential, and the like. In some embodiments, display 308 may be an LCD or similar display.

In some embodiments, the credential may correspond to a personal identification number (PIN). In some embodiments, the PIN may be a PIN generated based on a password, such as described in U.S. patent application Ser. No. 13/281,273, filed on Oct. 25, 2011, the entire contents of which is incorporated by reference herein in its entirety. In some embodiments, the credential may correspond to a secret identifier, which may be a credential that is known to user 110, and may be a number associated with user 110, or a combination of numbers associated with user 110. In some embodiments, a secret identifier may correspond to the last four digits of a Social Security number or other official number associated with user 110. In another embodiment, a secret identifier may correspond to a combination of the last four digits of a Social Security number of user 110 and a Zone Improvement Plan (ZIP) code of residence of user 110. In some embodiments, input unit 302 may include a card and/or integrated circuit (IC) chip reader, and the state may correspond to a credential associated with the card and/or IC chip. The credential may also be a combination of numbers, letters, character, pictograms, and the like, which may be traced in on input pad 306 of input device 302.

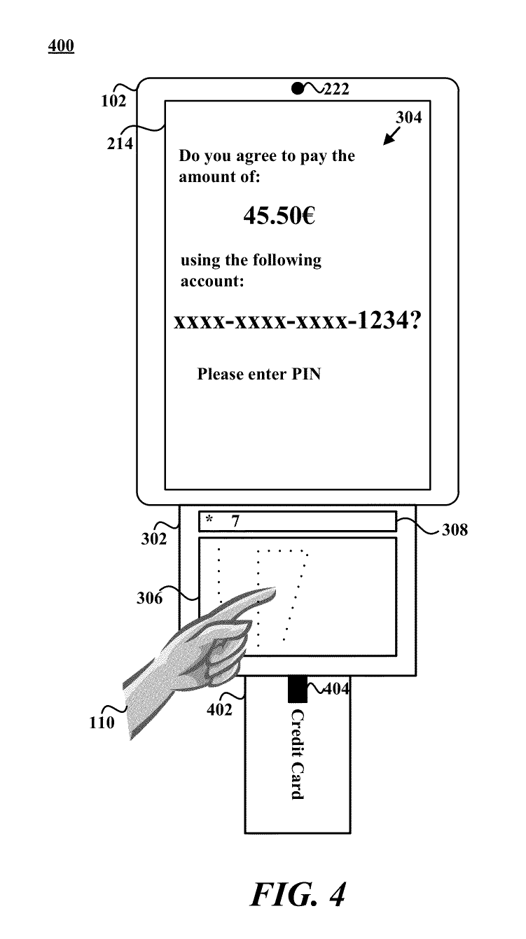

FIG. 4 is a diagram illustrating a system 400 including client computing device 102 in communication with input unit 302 having a card or IC chip reader, consistent with some embodiments. System 400 is similar to system 300 except that input unit 302 includes a card reader for reading a financial transaction card 402, such as a credit or debit card. Further, the card reader may also include an IC chip reader for reading an IC chip 404 that may be embedded on card 402. In some embodiments, IC chip 404 may include one or more processors and memory and may be capable of executing programs and performing actions when used with input unit 302 having an IC chip reader. Consistent with some embodiments, system 400 of input unit 302 and computing system 102 displaying user interface 304 may be capable of processing transactions using EMV or Chip and PIN credit cards. In such embodiments, input unit 302 may receive a tactile input from user 110 on input pad 306 that may be a PIN associated with card 402 and chip 404. In some embodiments, the entered PIN may serve as a digital signature to complete a transaction. For example user may trace the numbers of the PIN on input pad 306 and the one or more processors of input pad 306 may perform character recognition on the tactile input to recognize the PIN numbers that were entered by user 110. After the PIN numbers or characters have been recognized, input pad 302 may encrypt the entered PIN and other relevant information and send the encrypted information to client computing device 102. Payment application 112 of client computing device 102 may then send the received encrypted information to remote server 104 for processing the authorized payment. In some embodiments, input device 302 may check an accuracy or correctness of the credential entered by tactile input before transmitting to client computing device 102. In some embodiments, user 110 may be able to trace their signature on input 306 for implementations of a card reader that use “Chip and Signature” cards.

In some embodiments, input device 302 may be capable of activating card 402. For example, an unactivated card 402 may be inserted into input device 302, and a request to enter an identification or a PIN may be presented. The PIN and a number associated with card 402 may be encrypted and provided to client computing device 102, which may then transmit the encrypted PIN and number to an issuer of card 402 which may activate card 402 if the received encrypted PIN is correct.

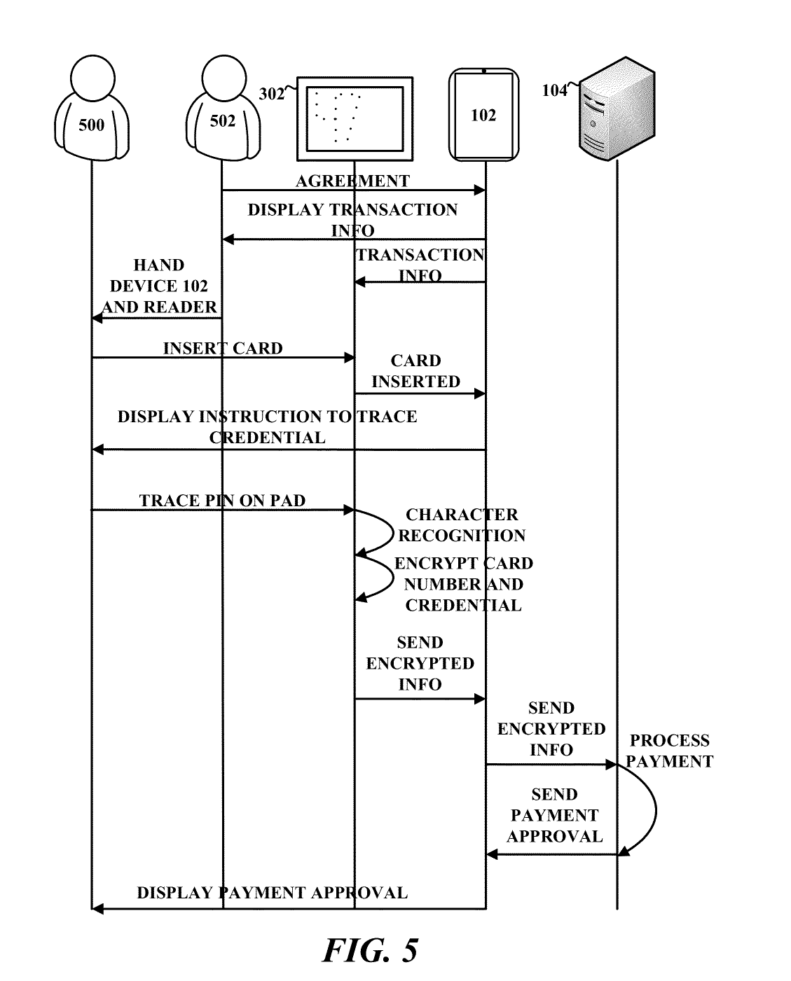

FIG. 5 is a diagram illustrating a flow of using system 400 to conduct a transaction, consistent with some embodiments. As shown in FIG. 5, conducting a transaction according to some embodiments involves a buyer 500, a merchant 502 (merchant 502 and buyer 500 may correspond to user 110 in previous FIGS.), input unit 302, client computing device 102, and remote server 104. An example transaction is described as follows with reference to FIG. 5. Buyer 500 and merchant 502 may enter into an agreement for buyer 500 to authorize a payment for the exchange or goods or services from merchant 502. Merchant 502 may enter the details of the agreement into client computing device 102, which may be used as a point-of-sale (POS) device for conducting the transaction. After details of the agreement have been entered into client computing device 102 by merchant 502, client computing device 102 may display the transaction information for review by merchant 502. Merchant 502 can make any changes based on the review. Client computing device 102 may also send some transaction information to input pad 302.

To authorize the transaction, merchant 502 may hand client computing device 102 having input device 302 coupled thereto to buyer 500. If buyer 500 agrees with the transaction information shown on display device 214 of client computing device 102, buyer 500 may insert their payment card 402 into input device 302. When payment card 402 has been inserted, input device 302 may send an indication to client computing device 102 that card 402 has been inserted. In some embodiments, if input device 302 is an EMV or chip and PIN or chip and signature device, input device 302 may check to see if card 402 includes IC chip 404 and read information from IC chip 404. Client computing device 102 may display instructions to buyer 500 to input a credential associated with card 402 and chip 404 to authorize a payment to complete the transaction.

Buyer 500 may then trace the credential, which may be a PIN, on input pad 306 of input device 302. One or more processors of input device 302 may perform character recognition on the traced credential and then encrypt the recognized credential. The card number, and other information may also be encrypted. The encrypted information may then be sent to client computing device 102. Client computing device 102 may then send the received encrypted information to remote server 104 over network 106. Payment processing application 116 of remote server 104 may then unencrypt the received information and process the payment based on the received card number, credential, and any other information that may be needed to authorize the payment. In some embodiments, buyer 500 and/or merchant 502 may have an account managed by remote server 104 such that the payment may be processed based on information stored in account information 120 of account database 118 of remoter server 104. When the payment has been processed, remote server 104 may send a payment approval to client computing device 102, and the payment approval may be displayed on display component 214 of client computing device 102 for buyer 500 and merchant 502 to view.

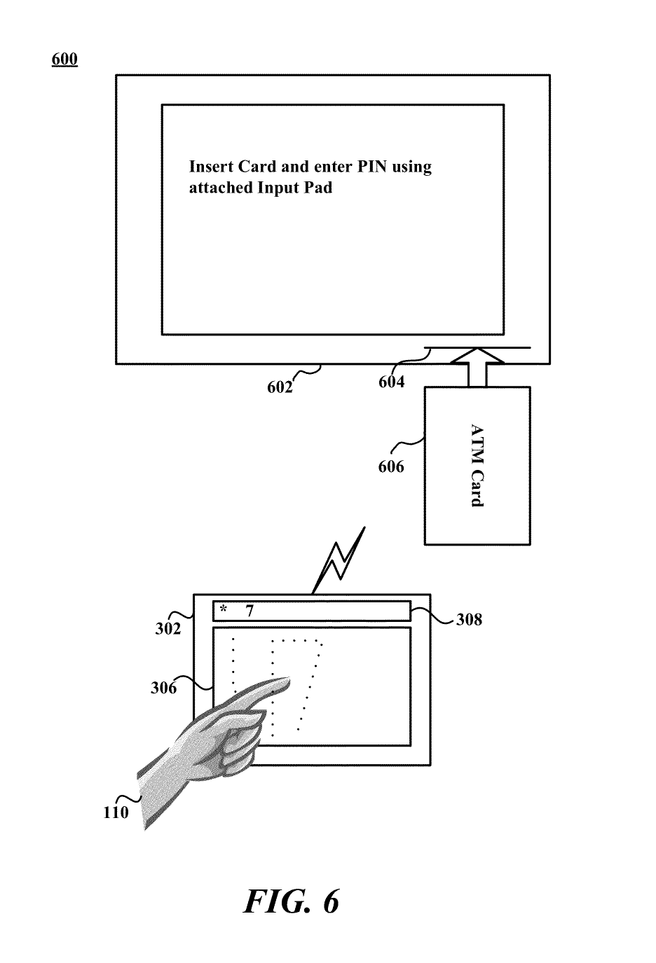

FIG. 6 is a diagram illustrating a system 600 including input device 302 in communication with an automatic teller machine, consistent with some embodiments. System 600 is similar to systems 300 and 400, except that input device 302 may be in communication with an ATM machine 602 having a card reader 604. Consistent with some embodiments, system 600 may operate in the same manner as system 300 or 400 except that input device 302 is in communication with ATM machine 602 and may be used to enter a credential to interact with ATM machine 602. In some embodiments, input device 302 is integrated as part of ATM machine 602. In some embodiments, input device 302 is in communication with ATM machine 602 wired or wirelessly. As shown in FIG. 6, ATM machine 602 may prompt a user, such as user 110, to insert a card 606 in card reader 604 and enter their credential, such as a PIN, on input device 302. The user may then enter their PIN by tracing components of the credential on input pad 306 of input device 302. Upon successful entry of the credential, the user may be able to interact with ATM machine 602. In addition to ATM machine 602, input device 302 may also be in communication with a register or other display and be used as part of a point-of-sale (POS) system.

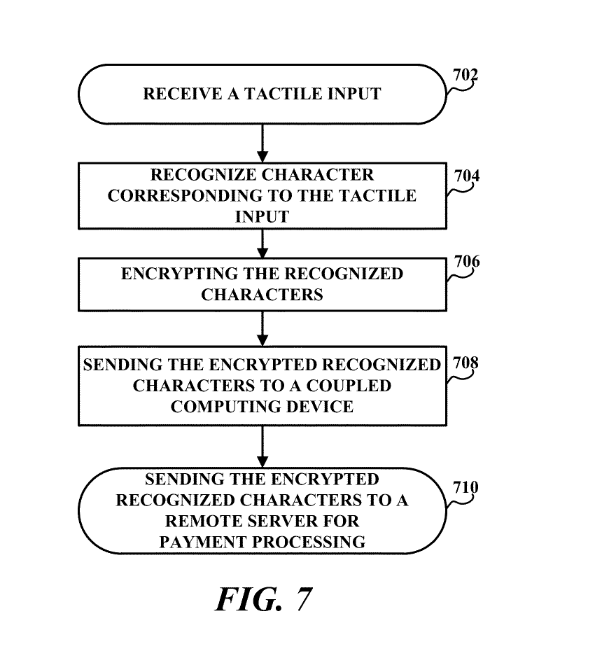

FIG. 7 is a flowchart illustrating a method for credential character entry, consistent with some embodiments. For the purpose of illustration, FIG. 7 may be described with reference to any of FIGS. 1-5. The method shown in FIG. 7 may be embodied in computer-readable instructions for execution by one or more processors such that the steps of the method may be performed by client computing device 102 and/or input device 302. As shown in FIG. 7, the method includes receiving a tactile input (702). In some embodiments, the received tactile input may correspond to credential components. Moreover, the received tactile input may correspond to a trace of the credential components on an input pad capable of detecting the tracing, such as a touch detecting input pad. The method may then recognize characters corresponding to the received tactile input (704). In some embodiments, one or more processors may perform one or more character recognition algorithms to recognize characters corresponding to the tactile input. For example, if user 110 traces a shape on pad 306 of input device, the one or more character recognition algorithms may recognize the traced shape as a number, such as a “4” or a “7”, such as shown in FIGS. 3 and 4. The character recognition algorithms may recognize the tactile input as corresponding to credential components, such as characters of a PIN.

The recognized characters may then be encrypted (706). In some embodiments, input device 302 includes one or more processors that may be used to encrypt the recognized characters and other information. In some embodiments, input device 302 may include a card slot or card reader for receiving a payment card 402. Input device 302 may also include an IC reader for reading an IC chip 404 embedded on payment card 402. Input device 302 may then encrypt information associated with IC chip 404 and payment card 402, such as the card number.

The encrypted recognized characters, and any other encrypted information, may then be sent to a coupled computing device (708). In some embodiments, input device 302 may be coupled to client computing device 102, wherein the coupling may be wired, wireless, or direct, such as through a port of client computing device 102. Input device 302 may not have any connection to external networks, such as the internet, or any payment processing networks, such as to isolate and protect input device 302 from malware. As a result, input device 302 may be coupled to client computing device 102, which is in communication with remote server 104 over network 106, so that input device 302 is capable of sending encrypted information to client computing device 102 for transmission over network 106. For example, client computing device 102 may then send the received encrypted recognized characters (and any other received encrypted information) to remote server 104 over network 106 (710). Remote server 104 may then process a payment according to the received encrypted information. In some embodiments, the received encrypted information authorizes a payment. For example, the received encrypted information may correspond to a PIN number and card number, and remote server 104 may process the payment based on the card number and the PIN number, and authorize a payment to be made using the card number. Remote server 104 may then send a payment confirmation or approval if the received credential characters match stored credential characters associated with user 110 and/or a received card number. If there is no match, remote server 104 may send a payment denial.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may provide methods, systems, and devices capable of securely processing transactions involving a PIN using tactile input, capture, and recognition of the PIN. In particular, embodiments as described herein may be used to enable secure mobile payment processing of chip and PIN cards using a mobile device and mobile card and IC chip reader. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system for entering credential components, comprising:
an input device comprising:
an input pad configured to receive a tactile input corresponding to the credential components; and
one or more processors configured to:
recognize the credential components from the received tactile input;
encrypt the recognized credential components; and
send the encrypted credential components; and
a computing device coupled to the input device, the computing device receiving the encrypted one or more characters, the computing device comprising:
one or more processors configured to:
display instructions to provide the tactile input; and
send the received encrypted one or more characters to a remote server.

2. The system of claim 1, wherein the input device further comprises a card slot configured to receive a payment card.

3. The system of claim 2, wherein the payment card comprises a payment card having an integrated circuit (IC) chip embedded thereon.

4. The system of claim 1, wherein the credential components comprise numbers of a personal identification number (PIN).

5. The system of claim 1, wherein the credential components comprise at least one of numbers, letters, character, pictograms, and a combination thereof.

6. The system of claim 1, wherein the one or more processors of the computing device are further configured to display a payment approval based on the sent received encrypted one or more characters.

7. The system of claim 1, wherein the computing device is physically coupled to the input device.

8. The system of claim 1, wherein the computing device is wirelessly coupled to the input device.

9. The system of claim 1, wherein the received encrypted one or more character are sent to the remote server to authorize a payment processed by the remote server.

10. The system of claim 2, wherein the one or more processors of the input device are further configured to encrypt a card number of the payment card and send the encrypted card number to the computing device.

11. The system of claim 1, wherein the one or more processors of the input device are configured to recognize one or more characters traced on the input pad by the tactile input using one or more character recognition algorithms.

12. The system of claim 1, wherein the input device further comprises a display configured to display the recognized credential components.

13. The system of claim 1, wherein the display is further configured to temporarily display the recognized credential components.

14. A method for credential component entry, comprising:
receiving, by an input pad of an input device, a tactile input corresponding to credential components;
recognizing, by one or more processors of the input device, the credential components from the received tactile input;
encrypting, by the one or more processors of the input device, the recognized credential components;
receiving, by a computing device coupled to the input device, the encrypted recognized credential components; and
sending, by the computing device, the encrypted recognized credential components to a remote server.

15. The method of claim 14, further comprising receiving, by the input device, a payment card having a card number and an integrated circuit (IC) chip embedded thereon.

16. The method of claim 15, wherein encrypting the recognized credential components further comprises encrypting the card number.

17. The method of claim 16, wherein receiving the encrypted recognized credential components further comprises receiving the encrypted card number.

18. The method of claim 14, wherein receiving a tactile input corresponding to credential components comprises detecting a shape traced by the tactile input.

19. The method of claim 18, wherein detecting a shape traced by the tactile input comprises detecting one or more numbers of a personal identification number (PIN).

20. The method of claim 18, wherein detecting a shape traced by the tactile input comprises detecting at least one of numbers, letters, character, pictograms, and a combination thereof

21. The method of claim 14, further comprising:
displaying, by the computing device, credential component entry instructions before receiving the tactile input corresponding to the credential components; and
displaying, by the computing device, transaction approval information received from the remote server.

22. The method of claim 14, wherein recognizing characters corresponding to the tactile input comprises performing one or more character recognition algorithms on the received tactile input.

23. The method of claim 14, further comprising temporarily displaying, by the input device, the recognized credential components.
